(19) United States
(12) Patent Application Publication
(10) Pub. No.: US 2016/0324213 A1
(43) Pub. Date: Nov. 10, 2016

(54) ELECTRONIC CIGARETTE AND BATTERY ROD THEREOF

(71) Applicant: KIMREE HI-TECH INC., Virgin Islands, British (VG)

(72) Inventor: Qiuming LIU, Guangdong (CN)

(21) Appl. No.: 14/366,049

(22) PCT Filed: Dec. 26, 2013
(86) PCT No.: PCT/CN2013/090538

§ 371 Date: Jun. 17, 2014

(30) Foreign Application Priority Data
Dec. 16, 2013 (CN) 201320830916.0

(51) Int. Cl. A24F 47/00; H01M 2/02

(52) U.S. Cl. CPC A24F 47/008; H01M 2/022; H01M 2/0267; H01M 2/0287; H01M 2220/30

(57) ABSTRACT

A battery rod according to the present application includes a main body having one end arranged with a connecting member configured to fit an atomizer and the other end arranged with an end cap. A first battery sleeve and a second battery sleeve are coaxially sleeved on an outer periphery of the main body, and outer peripheral surfaces of the first battery sleeve and the second battery sleeve constitute an outer peripheral surface of the battery rod. The first battery sleeve is a metallic member, and the second battery sleeve is a non-metallic member. The first battery sleeve and the second battery sleeve have a light whole weight while ensuring the structural stability of the electronic cigarette, thereby improving touch feeling of the electronic cigarette. An electronic cigarette with the battery rod is further provided.

This application claims the benefit of priority to Chinese patent application No. 201320830916.0 titled “ELECTRONIC CIGARETTE AND BATTERY ROD THEREOF”, filed with the Chinese State Intellectual Property Office on Dec. 16, 2013, the entire disclosure of which is incorporated herein by reference.

### FIELD

The present application relates to the technical field of electronic cigarette accessories, and particularly to a battery rod. The present application further relates to an electronic cigarette having the battery rod.

### BACKGROUND

An electronic cigarette is a common electronic simulated cigarette product, and a battery rod, as a main structural component of the electronic cigarette, plays an essential role in the whole working effect of the electronic cigarette. Higher performance for the battery rod is required as the production and usage requirements are continuously increased.

In an exiting electronic cigarette, a battery sleeve arranged outside the battery rod is generally a steel tube member, though the battery rod made of such material can meet the stability requirement of the main structure of the electronic cigarette, a poor hand feeling and usage experience may be caused to a user since such material is hard and heavy, and the battery sleeve is apt to scald the user's hand in smoking. Furthermore, when being used in a low temperature environment, the battery sleeve made of steel tube will give a cold feel, which causes discomfort to the user.

Therefore, a technical problem to be solved presently by the person skilled in the art is to improve touch feeling and usage experience of the electronic cigarette while ensuring the structural stability thereof.

### SUMMARY

A battery rod is provided according to the present application, which may improve hand feeling and usage experience of an electronic cigarette while ensuring the structural stability of the electronic cigarette. An electronic cigarette having the battery rod is further provided according to the present application.

For solving the above technical problems, a battery rod according to the present application includes a main body, wherein the main body has one end arranged with a connecting member configured to fit an atomizer, and the other end arranged with an end cap, at least one first battery sleeve and at least one second battery sleeve are coaxially sleeved on an outer periphery of the main body, and an outer peripheral surface of the first battery sleeve and an outer peripheral surface of the second battery sleeve constitute an outer peripheral surface of the battery rod, and the first battery sleeve is a metallic member, and the second battery sleeve is a non-metallic member.

Preferably, the second battery sleeve is coaxially sleeved on the first battery sleeve at a portion away from the end cap, and the outer peripheral surface of the second battery sleeve is flush with the outer peripheral surface of the first battery sleeve at two sides of the second battery sleeve in an axial direction of the second battery sleeve.

Preferably, the first battery sleeve is coaxially sleeved on two ends of the second battery sleeve, and the outer peripheral surface of the second battery sleeve is flush with the outer peripheral surface of the first battery sleeve at two sides of the second battery sleeve in an axial direction of the second battery sleeve.

Preferably, the first battery sleeve is coaxially sleeved on the main body at an end close to the end cap, and the second battery sleeve is coaxially sleeved on the main body at an end away from the end cap, and the outer peripheral surface of the second battery sleeve is flush with the outer peripheral surface of the first battery sleeve.

Preferably, the first battery sleeve is coaxially sleeved on the main body at an end away from the end cap, and the second battery sleeve is coaxially sleeved on the main body at an end close to the end cap, and the outer peripheral surface of the second battery sleeve is flush with the outer peripheral surface of the first battery sleeve.

Preferably, the first battery sleeve and the second battery sleeve are sleevedly connected.

Preferably, the first battery sleeve is a stainless steel member.

Preferably, the second battery sleeve is any one of a rubber member, a silicon rubber member, a wooden member, and a paper member.

Preferably, the second battery sleeve is a non-metallic member with a hardness less than that of copper.

An electronic cigarette is further provided according to the present application, which includes a battery rod and an atomizer which are threadedly assembled, and the battery rod is any one of the above battery rods.

Compared to the background art, the battery rod according to the present application includes a main body. The main body had one end arranged with a connecting member configured to fit an atomizer, and the other end arranged with an end cap. A first battery sleeve and a second battery sleeve are coaxially sleeved on an outer periphery of the main body, and an outer peripheral surface of the first battery sleeve and an outer peripheral surface of the second battery sleeve together constitute an outer peripheral surface of the battery rod. The first battery sleeve is a metallic member, and the second battery sleeve is a non-metallic member. During the working progress, the first battery sleeve and the second battery sleeve of two different materials, i.e. metallic material and non-metallic material, have a light whole weight while ensuring the structural stability of the electronic cigarette, thus in smoking the smoker may hold the second battery sleeve made of non-metallic material, thereby avoiding the hand being scalded by the battery sleeve, effectively improving touch feeling and hand feeling of the electronic cigarette, and improving the user experience correspondingly.

### BRIEF DESCRIPTION OF THE DRAWINGS

For more clearly illustrating embodiments of the present application or the technical solution in the conventional technology, drawings referred to describe the embodiments or the conventional technology will be briefly described hereinafter. Apparently, the drawings in the following description are only several embodiments of the present application, and for the person skilled in the art other drawings may be obtained based on these drawings without any creative efforts.

FIG. 1 is a schematic view showing the assembled structure of a battery rod of a first structure according to an embodiment of the present application;

FIG. 2 is a schematic view showing the assembled structure of a battery rod of a second structure according to an embodiment of the present application;

FIG. 3 is a schematic view showing the assembled structure of a battery rod of a third structure according to an embodiment of the present application; and

FIG. 4 is a schematic view showing the assembled structure of a battery rod of a fourth structure according to an embodiment of the present application.

### DETAILED DESCRIPTION

A battery rod is provided according to the present application, which may improve hand feeling and usage experience of an electronic cigarette while ensuring the structural stability of the electronic cigarette. An electronic cigarette having the battery rod is further provided according to the present application.

For those skilled in the art to better understand technical solutions of the present application, the present application is described in detail in conjunction with drawings and embodiments hereinafter.

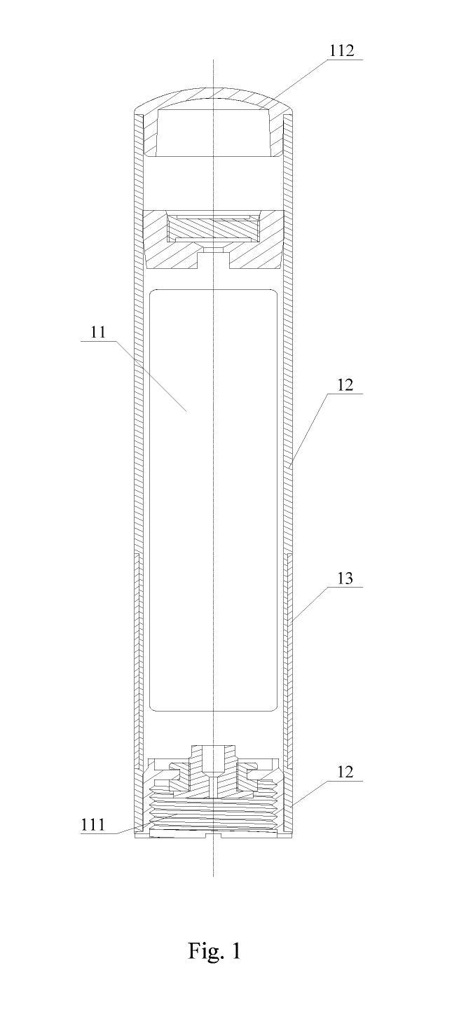

Reference is made to FIG. 1, which is a schematic view showing the assembled structure of a battery rod of a first structure according to an embodiment of the present application.

In this embodiment, the battery rod according to the present application includes a main body 11. The main body 11 had one end arranged with a connecting member 111 configured to fit an atomizer, and the other end arranged with an end cap 112. A first battery sleeve 12 and a second battery sleeve 13 are coaxially sleeved on an outer periphery of the main body 11, and an outer peripheral surface of the first battery sleeve 12 and an outer peripheral surface of the second battery sleeve 13 together constitute an outer peripheral surface of the battery rod. The first battery sleeve 12 is a metallic member, and the second battery sleeve 13 is a non-metallic member. During the working progress, the first battery sleeve 12 and the second battery sleeve 13 of two different materials, i.e. metallic material and non-metallic material, may improve touch feeling and hand feeling of an electronic cigarette while ensuring the structural stability of the electronic cigarette, and improve the user experience correspondingly.

Further, the second battery sleeve 13 is coaxially sleeved on the first battery sleeve 12 at a portion away from the end cap 112, and the outer peripheral surface of the second battery sleeve 13 is flush with the outer peripheral surface of the first battery sleeve 12 at two sides of the second battery sleeve 13 in an axial direction of the second battery sleeve 13. The battery rod with such structure may meet the usage requirement of the user who is accustomed to hold an electronic cigarette at the middle portion while ensuring the structural stability of the electronic cigarette.

Further, the connecting member 111 is a copper member having internal threads. Apparently, the connecting member 111 may be a magnetic member connected to the atomizer by magnetic attraction, or an elastic member connected to the atomizer by tight fit, which is not limited herein.

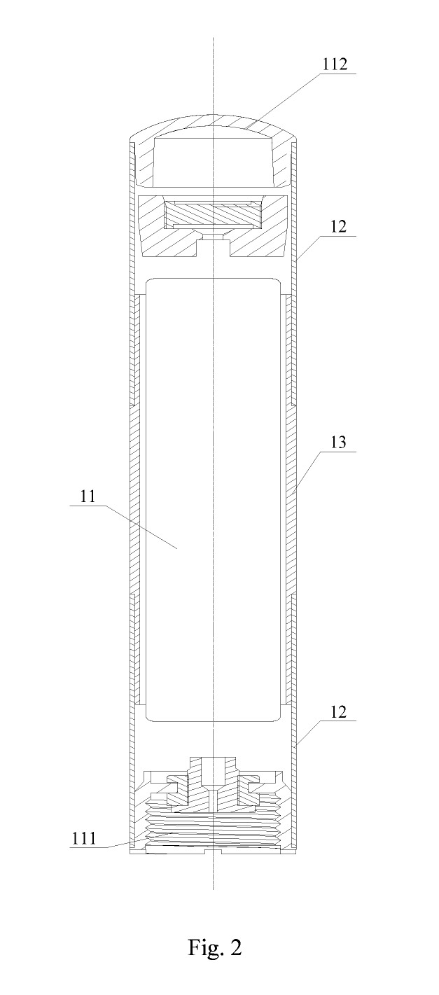

Reference is made to FIG. 2, which is a schematic view showing the assembled structure of a battery rod of a second structure according to an embodiment of the present application.

In this embodiment, the first battery sleeve 12 is coaxially sleeved on two ends of the second battery sleeve 13, and the outer peripheral surface of the second battery sleeve 13 is flush with the outer peripheral surface of the first battery sleeve 12 at the two sides of the second battery sleeve 13 in the axial direction of the second battery sleeve 13. The outer peripheral surfaces of the first battery sleeve 12 and the second battery sleeve 13 constitute the outer peripheral surface of the battery rod. The battery rod with such structure may meet the usage requirement of the user who is accustomed to hold an electronic cigarette at the front portion while ensuring the structural stability of the electronic cigarette.

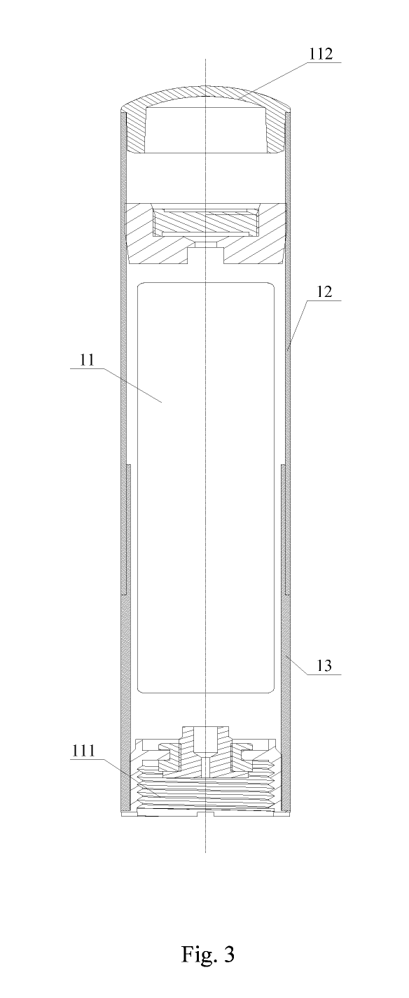

Reference is made to FIG. 3, which is a schematic view showing the assembled structure of a battery rod of a third structure according to an embodiment of the present application.

In this embodiment, the first battery sleeve 12 is coaxially sleeved on the main body 11 at an end close to the end cap 112, and the second battery sleeve 13 is coaxially sleeved on the main body 11 at an end away from the end cap 112, and the outer peripheral surface of the second battery sleeve 13 is flush with the outer peripheral surface of the first battery sleeve 12. The outer peripheral surfaces of the first battery sleeve 12 and the second battery sleeve 13 constitute the outer peripheral surface of the battery rod. The battery rod with such structure may meet the usage requirement of the user who is accustomed to hold an electronic cigarette at the middle portion while ensuring the structural stability of the electronic cigarette.

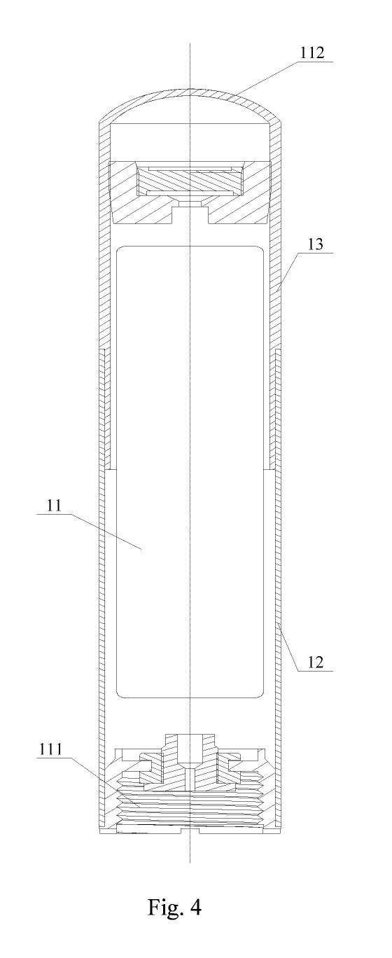

Reference is made to FIG. 4, which is a schematic view showing the assembled structure of a battery rod of a fourth structure according to an embodiment of the present application.

In this embodiment, the first battery sleeve 12 is coaxially sleeved on the main body 11 at the end away from the end cap 112, and the second battery sleeve 13 is coaxially sleeved on the main body 11 at the end close to the end cap 112, and the outer peripheral surface of the second battery sleeve 13 is flush with the outer peripheral surface of the first battery sleeve 12. The outer peripheral surfaces of the first battery sleeve 12 and the second battery sleeve 13 constitute the outer peripheral surface of the battery rod. The battery rod with such structure may meet the usage requirement of the user who is accustomed to hold an electronic cigarette at the front portion while ensuring the structural stability of the electronic cigarette.

Furthermore, the first battery sleeve 12 is a stainless steel member which may avoid the health of a smoker from being harmed by rusting of the first battery sleeve 12 caused by cigarette liquid, and the stainless steel member has a great rigidity which may better ensure the structural stability of the battery rod. Apparently, the first battery sleeve 12 is only preferable to be a stainless steel member, and is not limited to the above described steel member, and it may also be a copper member, an aluminum member, an alloy member, or the like, as long as the practical usage requirement of the electronic cigarette can be met.

Further, the second battery rod 13 is a non-metallic member with a hardness less than that of copper, therefore, the second battery sleeve 13 has a better flexibility, which improves the user experience. The second battery sleeve 13 may be any one of a rubber member, a silicon rubber member, a wooden member and a paper member. It is to be noted that, the second battery sleeve 13 is not limited to the rubber member, the silicon rubber member, the wooden member and the paper member, may also be members made of other materials as long as the practical usage requirement of the electronic cigarette can be met. The second battery sleeve 13 is preferably a rubber member or a silicon rubber member, thus has a better elasticity, which may not only further improve the user experience, but also better prevent the electronic cigarette from falling off from the hand of the user.

Further, the end cap 112 and the second battery sleeve 13 may be formed integrally, which reduces a process of mounting the end cap 112, thereby solving a problem that the end cap 112 is difficult to be mounted, and improving the production efficiency. Apparently, the end cap 112 and the second battery sleeve 13 may also be detachably connected, which is not limited herein.

In an embodiment, the electronic cigarette provided by the present application includes a battery rod and an atomizer detachably connected to the battery rod, and the battery rod is one of the battery rods according to the above embodiments. The electronic cigarette has a highly stable structure and gives a good hand feeling and usage experience.

In summary, the battery rod according to the present application includes a main body. The main body had one end arranged with a connecting member configured to fit an atomizer, and the other end arranged with an end cap. A first battery sleeve and a second battery sleeve are coaxially sleeved on an outer periphery of the main body, and an outer peripheral surface of the first battery sleeve and an outer peripheral surface of the second battery sleeve together constitute an outer peripheral surface of the battery rod. The first battery sleeve is a metallic member, and the second battery sleeve is a non-metallic member. During the working progress, the first battery sleeve and the second battery sleeve of two different materials, i.e. metallic material and non-metallic material, have a light whole weight while ensuring the structural stability of the electronic cigarette, thus in smoking the smoker may hold the second battery sleeve made of non-metallic material, thereby avoiding the hand being scalded by the battery sleeve, effectively improving touch feeling and hand feeling of the electronic cigarette, and improving the user experience correspondingly.

Furthermore, the electronic cigarette with the battery rod provided by the present application has a highly stable structure and gives a great hand feeling and usage experience.

The battery rod and the electronic cigarette with the battery rod provided by the present application are described in detail hereinbefore. The principle and the embodiments of the present application are illustrated herein by specific examples. The above description of examples is only intended to help the understanding of the method and the spirit of the present application. It should be noted that, for the person skilled in the art, many modifications and improvements may be made to the present application without departing from the principle of the present application, and these modifications and improvements are also deemed to fall into the protection scope of the present application defined by the claims.

1. A battery rod, comprising a main body, wherein the main body has one end arranged with a connecting member configured to fit an atomizer, and the other end arranged with an end cap, at least one first battery sleeve and at least one second battery sleeve are coaxially sleeved on an outer periphery of the main body, and an outer peripheral surface of the first battery sleeve and an outer peripheral surface of the second battery sleeve constitute an outer peripheral surface of the battery rod, and the first battery sleeve is a metallic member, and the second battery sleeve is a non-metallic member.

2. The battery rod according to claim 1, wherein the second battery sleeve is coaxially sleeved on the first battery sleeve at a portion away from the end cap, and the outer peripheral surface of the second battery sleeve is flush with the outer peripheral surface of the first battery sleeve at two sides of the second battery sleeve in an axial direction of the second battery sleeve.

3. The battery rod according to claim 1, wherein the first battery sleeve is coaxially sleeved on two ends of the second battery sleeve, and the outer peripheral surface of the second battery sleeve is flush with the outer peripheral surface of the first battery sleeve at two sides of the second battery sleeve in an axial direction of the second battery sleeve.

4. The battery rod according to claim 1, wherein the first battery sleeve is coaxially sleeved on the main body at an end close to the end cap, and the second battery sleeve is coaxially sleeved on the main body at an end away from the end cap, and the outer peripheral surface of the second battery sleeve is flush with the outer peripheral surface of the first battery sleeve.

5. The battery rod according to claim 1, wherein the first battery sleeve is coaxially sleeved on the main body at an end away from the end cap, and the second battery sleeve is coaxially sleeved on the main body at an end close to the end cap, and the outer peripheral surface of the second battery sleeve is flush with the outer peripheral surface of the first battery sleeve.

6. The battery rod according to claim 1, wherein the first battery sleeve and the second battery sleeve are sleevedly connected.

7. The battery rod according to claim 1, wherein the first battery sleeve is a stainless steel member.

8. The battery rod according to claim 1, wherein the second battery sleeve is any one of a rubber member, a silicon rubber member, a wooden member, and a paper member.

9. The battery rod according to claim 1, wherein the second battery sleeve is a non-metallic member with a hardness less than that of copper.

10. An electronic cigarette, comprising a battery rod and an atomizer which are threadedly assembled, wherein the battery rod comprises a main body, the main body has one end arranged with a connecting member configured to fit an atomizer, and the other end arranged with an end cap, at least one first battery sleeve and at least one second battery sleeve are coaxially sleeved on an outer periphery of the main body, and an outer peripheral surface of the first battery sleeve and an outer peripheral surface of the second battery sleeve constitute an outer peripheral surface of the battery rod, and the first battery sleeve is a metallic member, and the second battery sleeve is a non-metallic member

11. The electronic cigarette according to claim 10, wherein the second battery sleeve is coaxially sleeved on the first battery sleeve at a portion away from the end cap, and the outer peripheral surface of the second battery sleeve is flush with the outer peripheral surface of the first battery sleeve at two sides of the second battery sleeve in an axial direction of the second battery sleeve.

12. The electronic cigarette according to claim 10, wherein the first battery sleeve is coaxially sleeved on two ends of the second battery sleeve, and the outer peripheral surface of the second battery sleeve is flush with the outer peripheral surface of the first battery sleeve at two sides of the second battery sleeve in an axial direction of the second battery sleeve.

13. The electronic cigarette according to claim 10, wherein the first battery sleeve is coaxially sleeved on the main body at an end close to the end cap, and the second battery sleeve is coaxially sleeved on the main body at an end away from the end cap, and the outer peripheral surface of the second battery sleeve is flush with the outer peripheral surface of the first battery sleeve.

14. The electronic cigarette according to claim 10, wherein the first battery sleeve is coaxially sleeved on the main body at an end away from the end cap, and the second battery sleeve is coaxially sleeved on the main body at an end close to the end cap, and the outer peripheral surface of the second battery sleeve is flush with the outer peripheral surface of the first battery sleeve.

15. The electronic cigarette according to claim 10, wherein the first battery sleeve and the second battery sleeve are sleevedly connected.

16. The electronic cigarette according to claim 10, wherein the first battery sleeve is a stainless steel member.

17. The electronic cigarette according to claim 10, wherein the second battery sleeve is any one of a rubber member, a silicon rubber member, a wooden member, and a paper member.

18. The electronic cigarette according to claim 10, wherein the second battery sleeve is a non-metallic member with a hardness less than that of copper.
